(19) United States
(12) Patent Application Publication
(10) Pub. No.: US 2020/0315209 A1
(43) Pub. Date: Oct. 8, 2020

(54) PLANT-BASED MEAT ALTERNATIVE COMPOSITIONS

(71) Applicant: KALAMAZOO HOLDINGS, INC., Kalamazoo, MI (US)

(72) Inventors: Julie BONNER-HEINE, Coloma, MI (US); Ashley Huff, Holland, MI (US); Amber Beckett, Kalamazoo, MI (US); Deepti Dabas, Portage, MI (US); Carol Locey, Manistee, MI (US)

(21) Appl. No.: 16/825,090

(22) Filed: Mar. 20, 2020

Related U.S. Application Data
(60) Provisional application No. 62/829,700, filed on Apr. 5, 2019.

(51) Int. Cl. A23J 3/22; A23L 27/00; A23J 3/16; A23L 27/10; A23L 5/43

(52) U.S. Cl. CPC A23J 3/227; A23L 27/72; A23V 2002/00; A23L 27/10; A23L 5/43; A23J 3/16

(57) ABSTRACT

The present invention relates to plant-based protein products containing compositions comprising a flavoring, or a coloring and a flavoring, which products mimic the gray-brown appearance of cooked animal meat or both the red appearance of raw animal meat and gray-brown appearance of cooked animal meat. The plant-based protein products of the present invention may serve as meat alternatives or substitutes for animal meat products.

### FIELD OF THE INVENTION

The present invention relates to plant-based protein products containing compositions comprising a flavoring, or a coloring and a flavoring, which products mimic the gray-brown appearance of cooked animal meat or both the red appearance of raw animal meat and gray-brown appearance of cooked animal meat. The plant-based protein products of the present invention may serve as meat alternatives or substitutes for animal meat products, with color shifts resulting from the invention consistent with those found in animal meat products.

### BACKGROUND OF THE INVENTION

Plant-based protein demand has jumped dramatically in the last five years so that almost two-thirds of U.S. consumers now say they want to get more protein in their diets by mixing both animal meat and plant-based meat alternative products. Plant-based meat alternatives aren't just for vegetarians anymore. In fact, plant-based foods have become more available and tastier. Burgers, meatballs and other meat alternative products are driving demand in the foodservice industry. To keep driving growth in this area, plant-based meat alternatives need to look, smell and taste like their animal meat counterparts. Since these products are offered as healthier and more environmentally friendly alternatives to meat, the problem of matching meat aesthetics (raw and cooked) needs to be solved with natural flavors, natural extracts and naturally derived colorants.

The aesthetic issue is a well-known problem for plant-based meat alternative processed foods that seek to look like the animal-based originals. For example, EcoWatch explains how unappealing colors are overcome through industry color solutions https://www.ecowatch.com/plant-based-meat-color-257138573.html).

Food Navigator reinforces this need for color solutions to improve the appeal of plant-based alternatives (https://www.foodnavigator.com/Article/2018/05/16/What-are-the-best-colour-options-for-plant-based-meats).

Sensient, a business to business company specializing in color solutions for food, also points to the desire of alternative protein manufacturers to not have to compromise when it comes to matching the aesthetics of the original meat-based product. Sensient specifically points out a goal being “Pre-cooked red patty, but browned meat and juices post-cook” (httos://sensientfoodcolors.com/en-us/bakina/color-aesthetics-olant-based-meat-alternatives).

Raw animal meat-based products have a pink-red hue, while cooked animal meat products such as burgers, can be pink to gray to brown depending on the cooking source (baking, boiling, pan-frying, grilling or frying) and cooking time/level of doneness (rare, medium or well done).

Plant-based meat alternative products without the addition of colorants often appear pale beige or yellow toned due to the protein source and matrix composition and do not provide an appealing or animal meat like appearance to consumers. Post-cooking these products do not experience an improvement in the appearance of the plant-based meat alternative product to either be more appealing to consumers or to be more animal meat like in appearance.

A system that appears red prior to cooking and gray-brown after cooking is desirable for consumer products, while a system that appears gray-brown post cooking is desirable for both consumer and foodservice products.

The prior art does not describe a system that solves both problems simultaneously.

Plant-based meat alternative products with the addition of red colorants to achieve the desired pre-cooked appearance do not achieve the desired post cooking (gray-brown) characteristic that is expected in animal meat. These products remain too red, giving the appearance of undercooked animal meat and are unappealing to consumers due to food safety concerns associated with undercooked animal meat, as well as a general aversion in some to eating a raw meat product.

There is also a lack of suitable solutions for mimicking the gray-brown appearance of cooked animal meat. While the prior art describes brown solutions which can be added (https://sensientfoodcolors.com/en-us/research-development/dark-natural-brown-alternatives-caramel-colors/, https://sensientfoodcoors.com/en-us/baking/color-aesthetics-olant-based-meat-alternatives/), such solutions will typically result in a browning of the raw form, thereby resulting in an inferior red attribute prior to cooking, which is particularly unsuitable given consumers' negative perception of raw meat products that appear brown or grey.

Naturally derived colorant ingredients that could potentially produce the desired gray-brown characteristic are often undesirable due to consumer perception, regulatory permissibility, or are unstable in the plant-based meat alternative matrix and do not give the desired post-cooked affect.

Other naturally derived colorant ingredients that could potentially produce the gray-brown characteristic require cool temperatures and the absence of heating in order to cause this color shift, while a working system that induces the desired gray-brown color only upon cooking would need to be activated by the increased temperatures characteristic of cooking (Mellican, R. I., Li, J., Mehansho, H. & Nielsen, S. S. The role of iron and the factors affecting off-color development of polyphenols. J. Agric. Food Chem. 51, 2304-2316(2003)).

Green tea, as well as green tea extracts, have been utilized for nutraceutical, cosmetic, and medicinal purposes as well as being used for antioxidant properties (in food, cosmetics, and medicinal applications), antimicrobial activity, and in medical and disease-preventing applications (“Green Tea Extract-Patents and Diversity of Uses” Recent Patents on Food, Nutrition & Agriculture, 2009, 1, 203-215).

Pomegranate (Punica granatum) is a fruit bearing shrub grown all over the world and is used for culinary uses. In India's ancient Ayurveda system of traditional medicine, pomegranate is frequently described as an ingredient (Recent Trends in Horticulture in the Himalayas: Ed K K Jindal and R C Sharma, 2004, pp 139-146).

Beet extracts have been utilized for food, nutraceutical, cosmetic, and medicinal purposes as well as being used for colorant, antimicrobial, and antioxidant properties (in food, cosmetics, and medicinal applications) (https://www.medicalnewstoday.com/articles/277432.php and https://www.researchgate.net/publication/267031547_Antioxidant_and_Antimi crobial_Activities_of_Beet_Root_Pomace_Extracts).

### OBJECTS OF THE INVENTION

Surprisingly, the addition of a green tea extract composition to plant-based meat alternative products produces a system which achieves the desirable post cooking gray-brown characteristics without affecting the pre-cooked appearance.

Surprisingly, the addition of a combination of a beet extract composition and a green tea extract composition to plant-based meat alternative products produces a system which achieves a superior post cooking (gray-brown) characteristics, while also producing the desired animal meat appearance prior to cooking in the raw form.

Thus, it is an object of the present invention to provide plant-based protein products which contain a green tea extract composition, which plant-based protein products have suitable characteristics to make these products useful as meat alternatives or substitutes for animal meat products.

It is a further object of the invention to provide plant-based protein products which contain a beet extract composition in combination with a green tea extract composition, which plant-based protein products have suitable characteristics to make these products useful as meat alternatives or substitutes for animal meat products.

Surprisingly, the addition of a pomegranate extract composition to plant-based meat alternative products produces a system which achieves the desirable post cooking gray-brown characteristics without affecting the pre-cooked appearance.

Surprisingly, the addition of a combination of a beet extract composition and a pomegranate extract composition to plant-based meat alternative products produces a system which achieves a superior post cooking (gray-brown) characteristics, while also producing the desired animal meat appearance prior to cooking in the raw form.

This is particularly surprising given both the challenge related to so closely mimicking the color shift of cooked meat while retaining the visual appearance of uncooked meat in the raw form, and given that previous studies examining color shifts in a model system observed the opposite reaction-increasing heat decreased gray/brown color development while in our system heat was a prerequisite for the color shift (Mellican, R. I., Li, J., Mehansho, H. & Nielsen. S. S. The role of iron and the factors affecting off-color development of polyphenols. J. Agric. Food Chem. 51, 2304-2316 (2003)).

Thus, it is an object of the present invention to provide plant-based protein products which contain a pomegranate extract composition, which plant-based protein products have suitable characteristics to make these products useful as meat alternatives or substitutes for animal meat products.

It is a further object of the invention to provide plant-based protein products which contain a beet extract composition in combination with a pomegranate extract composition, which plant-based protein products have suitable characteristics to make these products useful as meat alternatives or substitutes for animal meat products.

### SUMMARY OF THE INVENTION

The present invention relates to a composition comprising one or more plant-based protein products and a flavorant.

A further aspect of the invention relates to such a composition wherein the flavorant is a composition comprising a flavor extract selected from one or more flavoring extractive(s) belonging to the families of Lamiaceae, Theaceae, Grossulariaceae, Vitaeceae, Capressaceae, Rosaceae, Polygonaceae, Lythraceae, Irvingiaceae, Lauraceae, Ericaceae, Rubiaceae, Apiaceae, Malvaceae, Myrtaceae, Linaceae, Fagaceae, Asteraceae, Amaryllidaceae, Amaranthaceae, and/or any other family containing polyphenols.

A further aspect of the invention relates to such a composition wherein the flavorant comprises a green tea extract composition.

A further aspect of the invention relates to such a composition wherein the green tea extract is present at 50 ppb-5000 ppm catechins.

A further aspect of the invention relates to such a composition wherein the flavorant comprises a pomegranate extract composition.

A further aspect of the invention relates to such a composition wherein the pomegranate extract is present at 10 ppm-50000 ppm.

A further aspect of the invention relates to such a composition wherein the flavorant comprises a gooseberry extract composition.

A further aspect of the invention relates to such a composition wherein the flavorant comprises a gallnut extract composition.

A further aspect of the invention relates to a composition as defined above which further comprises a colorant.

A further aspect of the invention relates to such a composition wherein the colorant is a composition comprising a naturally derived colorant selected from one or more naturally derived colorant(s) belonging to the families of Amaranthaceae, Dactylopiidae, Brassicaceae, Convolvulaceae, Rosaceae, Apiaceae, Vitaceae, Ericaceae, Solanaceae, Lythraceae, Arecaceae, Fabaceae, Cannaceae, Grossularaceae, Polygonaceae, Poaceae, Dioscoreaceae, Violaceae, Bixaceae, Amaranthoideae, Papaveraceae, Balsaminaceae, Alstroemeriaceae, Amaryllidaceae, Plumbaginaceae, Geraniaceae, Araceae, Primulaceae, Margarodidae, or Apocynaceae.

A further aspect of the invention relates to such a composition wherein the colorant comprises a beet extract composition.

A further aspect of the invention relates to such a composition wherein beet extract is present at 1500 ppb-500 ppm betalains.

A further aspect of the invention relates to such a composition wherein the flavorant comprises a green tea extract composition and the colorant comprises a beet extract composition.

A further aspect of the invention relates to such a composition wherein the beet extract is present at 1500 ppb-500 ppm betalains and the green tea extract is present at 50 ppb-5000 ppm of catechins.

A further aspect of the invention relates to such a composition wherein the flavorant comprises a pomegranate extract composition and the colorant comprises a beet extract composition.

A further aspect of the invention relates to such a composition wherein the beet extract is present at 1500 ppb-500 ppm betalains and the pomegranate extract is present at 10 ppm-50000 ppm.

A further aspect of the invention relates to a composition as defined above, wherein the flavorant is encapsulated.

A further aspect of the invention relates to a composition as defined above, wherein the plant-based protein product is derived from soybean, bean (including broad bean, kidney bean, lima bean, fava bean, and black bean), pea (including chickpea, cow pea, earth pea, sweet pea, pigeon pea, green pea, yellow pea, and snow pea) protein, legume, alfalfa, clover, lentil, nut, peanut, almond, potato, gluten, cereal, maize, rice, wheat, wheat gluten, barley, sorghum, millet, oat, rye, buckwheat, quinoa, hemp, fungal (e.g., mushrooms), carrots, celery, spinach, corn, canola, lupin, barley and other vegetables, legumes, grains, fungi, nuts, pulses, or mixtures thereof.

A further aspect of the invention relates to such a composition, wherein the plant-based protein product is derived from soybean, bean (including broad bean, kidney bean, lima bean, fava bean, and black bean), pea (including chickpea, cow pea, earth pea, sweet pea, pigeon pea, green pea, yellow pea, and snow pea) protein, or mixtures thereof.

A further aspect of the invention relates to such a composition, wherein the plant-based protein product is in the form of a ground meat, meatball, a burger patty, hotdog, sausage, or cured meat.

A further aspect of the invention relates to a composition comprising a flavorant, which composition may be used to provide desired color characteristics to a plant-based protein product comprising treatment of the plant-based protein product.

A further aspect of the invention relates to such a composition wherein the flavorant is a composition comprising a flavor extract selected from one or more flavoring extractive(s) belonging to the families of Lamiaceae, Theaceae, Grossularaceae, Vitaeceae, Capressaceae, Rosaceae, Polygonaceae, Lythraceae, Irvingiaceae, Lauraceae, Ericaceae, Rubiaceae, Apiaceae, Malvaceae, Myrtaceae, Linaceae, Fagaceae, Asteraceae, Amaryllidaceae, Amaranthaceae and/or any other family containing polyphenols.

A further aspect of the invention relates to such a composition wherein the flavorant comprises a green tea extract composition.

A further aspect of the invention relates to such a composition wherein the green tea extract is present at 50 ppb-5000 ppm catechins.

A further aspect of the invention relates to such a composition wherein the flavorant comprises a pomegranate extract composition.

A further aspect of the invention relates to such a composition wherein the pomegranate extract is present at 10 ppm-50000 ppm.

A further aspect of the invention relates to such a composition wherein the flavorant comprises a gooseberry extract composition.

A further aspect of the invention relates to such a composition wherein the flavorant comprises a gallnut extract composition.

A further aspect of the invention relates to such a composition which further comprises a colorant.

A further aspect of the invention relates to such a composition wherein the colorant is a composition comprising a naturally derived colorant selected from one or more naturally derived colorant(s) belonging to the families of Amaranthaceae, Dactylopiidae, Brassicaceae, Convolvulaceae, Rosaceae, Apiaceae, Vitaceae, Ericaceae, Solanaceae, Lythraceae, Arecaceae, Fabaceae, Cannaceae, Grossulariaceae, Polygonaceae, Poaceae, Dioscoreaceae, Violaceae, Bixaceae, Amaranthoideae, Papaveraceae, Balsaminaceae, Alstroemeriaceae, Amaryllidaceae, Plumbaginacese, Geraniaceae, Araceae, Primulaceae, Margarodidae, or Apocynaceae.

A further aspect of the invention relates to such a composition wherein the colorant comprises a beet extract composition.

A further aspect of the invention relates to such a composition wherein beet extract is present at 1500 ppb-500 ppm betalains.

A further aspect of the invention relates to such a composition wherein the flavorant comprises a green tea extract composition and the colorant comprises a beet extract composition.

A further aspect of the invention relates to such a composition wherein the beet extract is present at 1500 ppb-500 ppm betalains and the green tea extract is present at 50 ppb-5000 ppm of catechins.

A further aspect of the invention relates to such a composition wherein the flavorant comprises a pomegranate extract composition and the colorant comprises a beet extract composition.

A further aspect of the invention relates to such a composition wherein the beet extract is present at 1500 ppb-500 ppm betalains and the pomegranate extract is present at 10 ppm-50000 ppm.

A further aspect of the invention relates to a composition as defined above, wherein the flavorant is encapsulated.

A further aspect of the invention relates to method for providing desired color characteristics to a plant-based protein product comprising treatment of the plant-based protein product with a composition as defined above.

A further aspect of the invention relates to such a method wherein the plant-based protein product is derived from legume, alfalfa, clover, pea, chickpea, cow pea, earth pea, sweet pea, pigeon pea, green pea, yellow pea, snow pea, bean, broad bean, kidney bean, lima bean, fava bean, black bean, soybean, lentil, nut, peanut, almond, potato, gluten, cereal, maize, rice, wheat, wheat gluten, barley, sorghum, millet, oat, rye, buckwheat, quinoa, hemp, fungal (e.g., mushrooms), carrots, celery, spinach, corn, canola, lupin, barley and other vegetables, legumes, grains, fungi, nuts, pulses, or mixtures thereof.

A further aspect of the invention relates to such a method wherein the plant-based protein product is derived from soybean, bean (including broad bean, kidney bean, lima bean, fava bean, and black bean), pea (including chickpea, cow pea, earth pea, sweet pea, pigeon pea, green pea, yellow pea, and snow pea) protein, or mixtures thereof.

A further aspect of the invention relates to such a method wherein the plant-based protein product is in the form of a ground meat, meatball, a burger patty, hotdog, sausage, or cured meat.

A further aspect of the invention relates to method for providing desired color characteristics to a plant-based protein product comprising treatment of the plant-based protein product with a composition comprising a colorant and a composition comprising an oxidizing agent, wherein the oxidizing agent is encapsulated.

A further aspect of the invention relates to such a method wherein the colorant is a composition comprising a naturally derived colorant selected from one or more naturally derived colorant(s) belonging to the families of Amaranthaceae, Dactylopiidae, Brassicaceae, Convolvulaceae, Rosaceae, Apiaceae, Vitaceae, Ericaceae, Solanaceae, Lythraceae, Arecaceae, Fabaceae, Cannaceae, Grossulariaceae, Polygonaceae, Poaceae, Dioscoreaceae, Violaceae, Bixaceae, Amaranthoideae, Papaveraceae, Balsaminaceae, Alstroemeriaceae, Amaryllidaceae, Plumbaginaceae, Geraniaceae, Araceae, Primulaceae, Margarodidae, or Apocynaceae.

A further aspect of the invention relates to such a method wherein wherein the colorant comprises a beet extract composition.

A further aspect of the invention relates to such a method wherein the oxidizing agent is ascorbic acid.

A further aspect of the invention relates to such a method wherein the plant-based protein product is derived from legume, alfalfa, clover, pea, chickpea, cow pea, earth pea, sweet pea, pigeon pea, green pea, yellow pea, snow pea, bean, broad bean, kidney bean, lima bean, fava bean, black bean, soybean, lentil, nut, peanut, almond, potato, gluten, cereal, maize, rice, wheat, wheat gluten, barley, sorghum, millet, oat, rye, buckwheat, quinoa, hemp, fungal (e.g., mushrooms), carrots, celery, spinach, corn, canola, lupin, barley and other vegetables, legumes, grains, fungi, nuts, pulses, or mixtures thereof.

A further aspect of the invention relates to such a method wherein the plant-based protein product is derived from soybean, bean (including broad bean, kidney bean, lima bean, fava bean, and black bean), pea (including chickpea, cow pea, earth pea, sweet pea, pigeon pea, green pea, yellow pea, and snow pea) protein, or mixtures thereof.

A further aspect of the invention relates to such a method wherein the plant-based protein product is in the form of a ground meat, meatball, a burger patty, hotdog, sausage, or cured meat.

### BRIEF DESCRIPTION OF THE DRAWINGS

FIG. 1 shows Gray intensity analysis of plant-based meat (pea based) images with or without 0.1% pomegranate extract, before and after cooking. A higher value along the Y-axis indicates an image that contains more white, while a lower score indicates an image that contains more black.

### DETAILED DESCRIPTION OF THE INVENTION

The present invention relates to plant-based protein products containing compositions comprising a flavoring, or a coloring and a flavoring, which products mimic the gray-brown appearance of cooked animal meat or both the red appearance of raw animal meat and gray-brown appearance of cooked animal meat. The plant-based protein products of the present invention may serve as meat alternatives or substitutes for animal meat products. The present invention also relates to the compositions comprising a flavoring, or a coloring and a flavoring, which may be used to provide desired characteristics in plant-based protein products intended to serve as meat alternatives or substitutes for animal meat products.

The compositions comprising a flavoring (such as a green tea extract composition or a pomegranate extract composition), when added to a plant-based protein product, produce a system which achieves the desirable post cooking gray-brown characteristics. These gray-brown characteristics are remarkably representative of the characteristics achieved in cooked animal meat products. The post cooked characteristics produced by the addition of such flavorant compositions are superior to characteristics achieved by the addition of naturally derived color ingredients to achieve the desirable gray-brown characteristics.

The compositions comprising a flavorant (such as a green tea extract composition or a pomegranate extract composition) and a colorant (such as a beet extract composition), when added to a plant-based protein product, produce a system which achieves superior post cooking (gray-brown) characteristics, while also producing the desired animal meat appearance (red) prior to cooking in the raw form.

Such characteristics are desirable since, when the gray-brown post cooking characteristics are achieved in a plant-based meat alternative product, consumers feel more assured of the food safety of the plant-based meat alternative product. Additionally, the aesthetic appearance of a true animal meat product is achieved both in the pre-cooked form and post cooked form, giving the true experience of an animal meat product without animal meat ingredients.

As used herein, the term colorant includes naturally derived colorant(s) belonging to the families of Amaranthaceae, Dactylopiidae, Brassicaceae, Convolvulaceae, Rosaceae, Apiacese, Vitaceae, Ericaceae, Solanaceae, Lythraceae, Arecaceae, Fabaceae, Cannaceae, Grossulariaceae, Polygonaceae, Poaceae, Dioscoreaceae, Violaceae, Bixaceae, Amaranthoideae, Papaveraceae, Balsaminaceae, Alstroemeriaceae, Amaryllidaceae, Plumbaginaceae, Geraniaceae, Araceae, Primulaceae, Margarodidae, or Apocynaceae.

As used herein, the term beet extract includes a dark red liquid, paste, powder or solid obtained from the roots of red beets (Beta vulgaris L var rubra) as pressed juice or by aqueous extraction of shredded beet roots. Beet extracts are composed of different pigments all belonging to the class betalain. The main coloring principle consists of betacyanins (red) of which betanin accounts for 75-95%; minor amounts of betaxanthin (yellow) and degradation products of betalains (light brown) may be present. Besides the color pigments, the juice or extract consists of sugars, salts and/or proteins naturally occurring in red beets. The extract may be concentrated, and some products may be refined in order to remove sugars, salts and/or proteins.

As used herein, the term beet extract also includes beet extract compositions which further comprise other suitable components, such as food grade acids (e.g., citric, lactic, L-ascorbic), stabilizers, carriers (e.g., maltodextrin), diluents, and emulsifiers (e.g. glycerin, water, propylene glycol, sunflower lecithin, etc.). (See, for example, www.fao.org/fileadmin/user_upload/jecfa_additives/docs/Monograph1/Additiva-052.pdf).

As used herein, the term flavorant includes flavoring extractive(s) belonging to the families of Lamiaceae, Theaceae, Grossularaceae, Vitaeceae, Capressaceae, Rosaceae, Polygonaceae, Lythraceae, Irvingiaceae, Lauraceae, Ericaceae, Rubiaceae, Apiaceae, Malvaceae, Myrtaceae, Linaceae, Fagaceae, Asteraceae, Amaryllidaceae, Amaranthaceae and/or any other family containing polyphenols.

As used herein, the term green tea extract includes a liquid, paste, powder or solid obtained from the leaves of tea plant (Camellia sinensis) by aqueous or solvent extraction of dried tealeaves. Green tea extracts are composed of a range of polyphenols mainly belonging to the class flavan-3-ois molecules, commonly referred to as catechins. Catechins account for 30-98% of the sample. Besides the primary catechin components, the green tea extract may consist of other polyphenols, sugars, caffeine, salts, and proteins naturally occurring in tea leaves. The extract may be concentrated, and some products may be refined in order to remove sugars, caffeine, salts, and/or proteins.

As used herein, the term green tea extract includes green tea extract compositions which further comprise carriers (e.g., maktodextrin, silica, etc.) and/or other suitable components, including emulsifiers (e.g., propylene glycol, polysorbates, diacetyl tartaric acid ester of mono- and diglycerides, canola oil, soybean oil, sunflower oil, polyglycerol polyricinoleate, ethanol, mono and diglycerides, etc.). Additionally, green tea extract compositions may contain catechin or other polyphenol derivatives created through enzymatic or chemical modification.

As used herein, the term pomegranate extract includes a liquid, paste, powder or solid obtained from the pomegranate plant (Punica Granatum) by aqueous or solvent extraction of plant matter. Pomegranate extracts are composed of a range of polyphenols accounting for 5-99% of the sample. Besides the primary polyphenol components, the pomegranate extract may consist of other sugars, salts, and proteins naturally occurring in leaves. The extract may be concentrated, and some products may be refined in order to remove sugars, salts, and/or proteins.

As used herein, the term pomegranate extract includes pomegranate extract compositions which further comprise carriers (e.g., maltodextrin, silica, etc.) and/or other suitable components, including emulsifiers (e.g., propylene glycol, polysorbates, diacetyl tartaric acid ester of mono- and diglycerides, canola oil, soybean oil, sunflower oil, polyglycerol polyricinoleate, ethanol, mono and diglycerides, etc.). Additionally, pomegranate extract compositions may contain other polyphenol derivatives created through enzymatic or chemical modification.

As used herein, the term plant-based protein product includes products comprising protein derived and/or isolated from one or more plant or modified plant sources.

As used herein, plant or modified plant sources include legume, alfalfa, clover, pea, chickpea, cow pea, earth pea, sweet pea, pigeon pea, green pea, yellow pea, snow pea, bean, broad bean, kidney bean, lima bean, fava bean, black bean, soybean, lentil, nut, peanut, almond, potato, gluten, cereal, maize, rice, wheat, wheat gluten, barley, sorghum, millet, oat, rye, buckwheat, quinoa, hemp, fungal (e.g., mushrooms), carrots, celery, spinach, corn, canola, lupin, barley and other vegetables, legumes, grains, fungi, nuts, and pulses.

As used herein, the term plant-based protein products includes products comprising protein derived and/or isolated from one or more plant or modified plant sources which further comprise one or more binding agents.

As used herein the term binding agents includes methyl cellulose, xanthan gum, carboxy methyl cellulose, carrageenan and other naturally derived gums.

As used herein, plant-based meat alternative products include food products not derived from animal meat sources but which have the structure, texture, and/or other properties comparable to those of animal meat. Such plant-based protein products may be in the form of a burger patty, meatball, hotdog, sausage, cured meat, ground meat, etc.

As used herein the term oxidizing agents includes ascorbic acid, azodicarbonamide, potassium bromate and potassium iodate.

As used herein the term encapsulating agents includes waxes (such as carnauba wax, candelilla wax, bees wax), proteins, and/or carbohydrates

### EXAMPLES

The following examples illustrate the invention without limiting its scope.

Green tea extract and/or beet extract compositions, as well as pomegranate extract and/or beet extract compositions, were evaluated to determine their ability to provide desired characteristics to a plant-based meat alternative burger product comprising a plant-based protein isolate. The desired characteristics include providing a red hue to the uncooked plant-based meat alternative product (to mimic the color of raw ground beef) and providing a gray-brown characteristic to the cooked product (to mimic the color of a cooked animal meat).

### Example 1—Characteristics Produced Using Red Beet Colorant

Red beet compositions provided a satisfactory red hue to the uncooked plant-based meat alternative product; however, the target gray-brown cooked appearance after pan cooking the product was not achieved since the overall surface and inside of the product remained too pink. This result gave the appearance of undercooked animal meat and is unappealing to consumers due to concerns with food safety attached to undercooked animal meat.

### Example 2—Characteristics Produced Using Green Tea Extract

Green tea powder was tested at the 550 ppm catechins level. Both direct addition (added powder to plant-based meat alternative and let sit for 5 minutes to hydrate) and pre-diluting sample of 10% green tea powder in water (to make sure green tea was hydrated in water) were tested. In the pre-cooked patty there was no appearance affect observed by the addition of green tea powder or pre-diluted green tea powder.

Surprisingly, the cooked plant-based meat alternative product appeared gray-brown at the 550 ppm catechin level, and the yellow hue of the base uncooked plant-based meat alternative product was gone. The resulting achieved gray-brown characteristic is remarkably representative of the characteristic achieved in cooked animal meat products. This result was unexpected as we did not expect any appearance effect with the addition of a green tea extract.

The plant-based meat alternative with direct addition of green tea powder was still slightly yellow toned after cooking, suggesting that the green tea powder was not fully dissolved into the matrix.

The flavor characteristics of the plant-based meat alternative containing a green tea extract at 550 ppm were very subtle and well rounded, providing an acceptable flavor.

### Example 3—Characteristics Produced Using a Combination of Red Beet and Green Tea

A comparative study was done to evaluate plant-based meat alternatives treated with beet extract compositions and plant-based meat alternatives treating with beet extract in combination with water soluble green tea extract (at the 550 ppm catechin level based on previous trials).

After pan cooking, the plant-based meat alternative product containing beet extract and green tea extract looked significantly more like cooked animal meat than it did without the addition of a green tea extract. The red tone in the plant-based meat alternative containing both beet extract and green tea extract was reduced after cooking both internally and on the surface of the plant-based meat alternative giving a realistic cooked meat appearance to the product. Without the addition of a green tea extract the plant-based meat alternative remained too red and gave the appearance of an undercooked animal meat which is unappealing to consumers due to concerns with food safety attached to undercooked animal meat.

These results demonstrate that the addition of green tea extract to the plant-based meat alternative greatly improved the post cook appearance of the plant-based meat alternative both with and without beet extract as a red color to give the desired pre-cooked animal meat appearance. With green tea extract alone, an excellent gray-brown after cooking the plant-based meat alternative was achieved that is more appealing as a cooked animal meat alternative by appearance.

Therefore, these results also indicate that a composition comprising a combination of beet extract and green tea extract is useful in providing desired aesthetic characteristics to alternative meat products to give the desired pre-cooked red appearance and the desired post cooking (gray-brown) characteristics which are expected in animal meat.

### Example 4—Characteristics Produced Using Carmine and/or Carminic Acid

Carmine and/or carminic acid compositions are evaluated to measure their ability to provide a satisfactory red hue to the uncooked plant-based meat alternative product and to achieve the target gray-brown cooked appearance after pan cooking the product.

The carmine and/or carminic acid compositions provide a satisfactory red hue to the uncooked plant-based meat alternative product; however, the target gray-brown cooked appearance after pan cooking the product is not achieved.

### Example 5—Characteristics Produced Using a Combination of Carmine and/or Carminic Acid and Green Tea

A study is performed to evaluate plant-based meat alternatives treated with carmine and/or carminic acid compositions in combination with water soluble green tea extract (at the 550 ppm catechin level based on previous trials) to measure the ability of such compositions to provide a satisfactory red hue to the uncooked plant-based meat alternative product and to achieve the target gray-brown cooked appearance after pan cooking the product.

The combination of carmine and/or carminic acid compositions and green tea extract provides satisfactory pre-cooking (red hue) and post-cooking (gray-brown appearance) to the plant-based meat alternative product.

### Example 6—Characteristics Produced Using Cranberry Extract

Cranberry extract compositions are evaluated to measure their ability to provide a satisfactory target gray-brown cooked appearance to the cooked plant-based meat alternative product after pan cooking the product.

The cranberry extract compositions provide the target gray-brown cooked appearance to the plant-based meat alternative product without affecting the pre-cooked appearance.

### Example 7—Characteristics Produced Using a Combination of Beet Extract and Cranberry Extract

A study is performed to evaluate plant-based meat alternatives treated with beet extract compositions in combination with cranberry extract to measure the ability of such compositions to provide a satisfactory red hue to the uncooked plant-based meat alternative product and to achieve the target gray-brown cooked appearance after pan cooking the product.

The combination of beet extract compositions and cranberry extract provides satisfactory pre-cooking (red hue) and post-cooking (gray-brown appearance) to the plant-based meat alternative product.

### Example 8—Characteristics Produced Using a Combination of Carmine and/or Carminic Acid and Cranberry Extract

A study is performed to evaluate plant-based meat alternatives treated with carmine and/or carminic acid compositions in combination with cranberry extract to measure the ability of such compositions to provide a satisfactory red hue to the uncooked plant-based meat alternative product and to achieve the target gray-brown cooked appearance after pan cooking the product.

The combination of carmine and/or carminic acid compositions and cranberry extract provides satisfactory pre-cooking (red hue) and post-cooking (gray-brown appearance) to the plant-based meat alternative product.

### Example 9—Characteristics Produced Using Pomegranate Extract

Pomegranate extract compositions are evaluated to measure their ability to provide a satisfactory target gray-brown cooked appearance to the cooked plant-based meat alternative product after pan cooking the product.

The pomegranate extract compositions provide the target gray-brown cooked appearance to the plant-based meat alternative product without affecting the pre-cooked appearance.

### Example 10—Characteristics Produced Using a Combination of Beet Extract and Pomegranate Extract

A study is performed to evaluate plant-based meat alternatives treated with beet extract compositions in combination with pomegranate extract to measure the ability of such compositions to provide a satisfactory red hue to the uncooked plant-based meat alternative product and to achieve the target gray-brown cooked appearance after pan cooking the product.

The combination of beet extract compositions and pomegranate extract provides satisfactory pre-cooking (red hue) and post-cooking (gray-brown appearance) to the plant-based meat alternative product.

### Example 11—Characteristics Produced Using a Combination of Carmine and/or Carminic Acid and Pomegranate Extract

A study is performed to evaluate plant-based meat alternatives treated with carmine and/or carminic acid compositions in combination with pomegranate extract to measure the ability of such compositions to provide a satisfactory red hue to the uncooked plant-based meat alternative product and to achieve the target gray-brown cooked appearance after pan cooking the product.

The combination of carmine and/or carminic acid compositions and pomegranate extract provides satisfactory pre-cooking (red hue) and post-cooking (gray-brown appearance) to the plant-based meat alternative product.

### Example 12: Pomegranate Extract Combined with Red Beet in a Pea Protein Based System

A comparative study was done to evaluate plant-based meat alternatives treated with beet extract compositions and plant-based meat alternatives treated with beet extract in combination with pomegranate extract (at 1000 ppm).

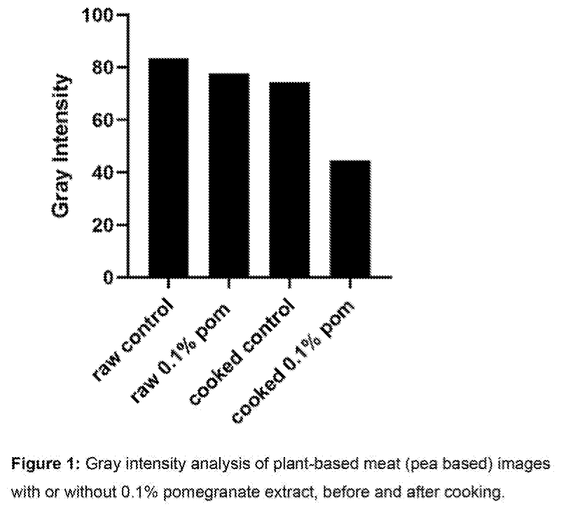

Upon cooking, the product containing the pomegranate extract exhibited significantly greater browning on the interior and exterior, and more closely resembled cooked meat than did the uncooked meat alternative containing the pomegranate, or the cooked meat alternative that did not contain the 1000 ppm pomegranate. A quantitative analysis of the images of the surface of the alternative meat patties revealed a synergistic darkening effect of heat plus pomegranate extract, as shown in FIG. 1.

Specifically, FIG. 1 shows a Gray intensity analysis of plant-based meat (pea based) images with or without 0.1% pomegranate extract, before and after cooking. A higher value along the Y-axis indicates an image that contains more white, while a lower score indicates an image that contains more black. The value decreased slightly in the raw form after the addition of pomegranate extract (indicating a slight darkening) and dropped slightly in the cooked control relative to the raw control. A much larger degree of darkening occurs in the cooked 0.1% pomegranate extract treated burger relative to either the raw 0.1% pomegranate extract treated burger, or to the cooked control burger.

This synergy is particularly surprising given that prior studies suggest the opposite effect is likely (with decreasing temperatures driving the color shift in a model system), however in our study heat was required to achieve the darkening effect (Mellican, R. I., Li, J., Mehansho, H. & Nielsen, S. S. The role of iron and the factors affecting off-color development of polyphenols. J. Agric. Food Chem. 51, 2304-2318 (2003)).

### Example 13—Characteristics Produced Using a Combination of Red Beet and Pomegranate in a Soybean-Based Meat Alternative System

A comparative study was done to evaluate plant-based meat alternatives treated with beet extract compositions and green tea extract compositions compared to plant based meat alternatives treated with beet extract compositions and pomegranate compositions.

After cooking, the soybean-based meat alternative product containing beet extract and green tea extract exhibited less graying/browning (and less closely resembled cooked animal meat) than did the pea protein-based system that was treated in a similar manner. However, when the experiment was repeated using 1000 ppm of pomegranate extract in the soy based system, the color shift that occurred upon cooking matched that which occurred in the pea protein based system which was treated similarly. The red tone in the plant-based meat alternative containing both beet extract and pomegranate extract was reduced after cooking both internally and on the surface of the plant-based meat alternative giving a realistic cooked meat appearance to the product.

### Example 14—Characteristics Produced Using a Combination of Red Beet and Amla (Indian Gooseberry Extract)

A comparative study was done to evaluate plant-based meat alternatives treated with beet extract in combination with gooseberry extract (1000 ppm).

Upon cooking, the product containing the Indian gooseberry extract exhibited significantly greater browning on the interior and exterior, and more closely resembled cooked meat than did the uncooked meat alternative containing the Indian gooseberry extract, or the cooked meat alternative that did not contain the Indian gooseberry extract.

### Example 16—Characteristics Produced Using a Combination of Red Beet and Gallnut Extract

A comparative study was done to evaluate plant-based meat alternatives treated with beet extract compositions and plant-based meat alternatives treating with beet extract in combination with gallnut extract (1000 ppm).

Upon cooking, the product containing the gallnut extract exhibited significantly greater browning on the interior and exterior, and more closely resembled cooked meat than did the uncooked meat alternative containing the gallnut extract, or the cooked meat alternative that did not contain the gallnut extract.

### Example 16—Characteristics Produced Using a Combination of Red Beet and Encapsulated Oxidizing Agents

A study is performed to evaluate plant-based meat alternatives treated with red beet extract in combination with an oxidizing agent, i.e. ascorbic acid, which has been encapsulated with an encapsulating agent that melts as the product is cooked.

During cooking, the oxidizing agent is exposed to the plant-based meat alternative where it acts to degrade the red beet color, giving the product a gray-brown cooked appearance.

### Example 17—Characteristics Produced Using a Combination of Red Beet and Encapsulated Green Tea

A study is performed to evaluate the plant-based meat alternatives treated with red beet extract in combination with green tea which has been encapsulated inside of an agent that melts as the product is cooked.

During cooking, the green tea is exposed and causes a gray-brown shift in the plant-based meat product, which gives a cooked meat appearance. The encapsulating agent protects the raw form of the plant-based meat from exposure to the green tea extract until the product is being cooked. This result is surprising as in prior studies the green tea extract was homogenously mixed into the plant-based protein matrix prior to cooking and exposed to all components of the matrix for the duration of heat exposure providing ample time for the color shift to occur. Here, the green tea extract was not homogenously incorporated into the matrix until partially through cooking (and it is released from the encapsulates), thus limiting the duration of heat plus exposure to matrix components required for the appearance shift.

### Example 18—Effect of Combining Red Beet with Encapsulated Pomegranate Extract

A study is performed to evaluate the plant-based meat alternatives treated with red beet extract in combination with pomegranate extract which has been encapsulated inside of an agent that melts as the product is cooked.

During cooking, the pomegranate extract is exposed and causes a gray-brown shift in the plant-based meat product, which gives a cooked meat appearance. The encapsulating agent protects the raw form of the plant-based meat from exposure to the pomegranate extract until the product is being cooked. This result is surprising as in prior studies the pomegranate extract was homogenously mixed into the plant-based protein matrix prior to cooking and exposed to all components of the matrix for the duration of heat exposure providing ample time for the color shift to occur. Here, the pomegranate extract was not homogenously incorporated into the matrix until partially through cooking (and it is released from the encapsulates), thus limiting the duration of heat plus exposure to matrix components required for the appearance shift.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All patents, applications, publications, test methods, literature, and other materials cited herein are hereby incorporated by reference.

1. A composition comprising one or more plant-based protein products and a flavorant.

2. The composition according to claim 1, wherein the flavorant comprises a green tea extract composition.

3. The composition according to claim 1, wherein the flavorant comprises a pomegranate extract composition.

4. The composition according to claim 1, which further comprises a colorant.

5. The composition according to claim 4, wherein the colorant comprises a beet extract.

6. The composition according to claim 2, wherein the green tea extract is present at 50 ppb-5000 ppm catechins.

7. The composition according to claim 6, further comprising a beet extract, which is present at 1500 ppb-500 ppm betalains.

8. The composition according to claim 3, wherein the pomegranate extract is present at 10 ppm-50000 ppm.

9. The composition according to claim 8, further comprising a beet extract, which is present at 1500 ppb-500 ppm betalains.

10. The composition according to claim 1, wherein the flavorant is encapsulated.

11. The composition according to claim 1, wherein the plant-based protein product is derived from soybean, bean (including broad bean, kidney bean, lima bean, fava bean, and black bean), pea (including chickpea, cow pea, earth pea, sweet pea, pigeon pea, green pea, yellow pea, and snow pea) protein, or mixtures thereof.

12. The composition according to claim 1, wherein the plant-based protein product is derived from legume, alfalfa, clover, lentil, nut, peanut, almond, potato, gluten, cereal, maize, rice, wheat, wheat gluten, barley, sorghum, millet, oat, rye, buckwheat, quinoa, hemp, fungal (e.g., mushrooms), carrots, celery, spinach, corn, canola, lupin, barley and other vegetables, legumes, grains, fungi, nuts, and pulses.

13. The composition according to claim 1, wherein the plant-based protein product is in the form of a ground meat, meatball, a burger patty, hotdog, sausage, cured meat, or ground meat.

14. A method for providing desired color characteristics to a plant-based protein product comprising treatment of the plant-based protein product with a composition comprising green tea extract and/or pomegranate extract.

15. The method according to claim 14, wherein the composition further comprises beet extract.

16. The method according to claim 14, further comprising treatment of the plant-based protein product with a beet extract.

17. The method according to claim 14, wherein the green tea extract and/or pomegranate extract is encapsulated.

18. The method according to claim 15, wherein the green tea extract and/or pomegranate extract is encapsulated.

19. The method according to claim 16, wherein the green tea extract and/or pomegranate extract is encapsulated.
